(19) United States
(12) Patent Application Publication
(10) Pub. No.: US 2007/0016772 A1
(43) Pub. Date: Jan. 18, 2007

(54) Methods and systems for managing securities among various trades

(76) Inventors: Thorsten Refior, Heidelberg (DE); Torsten Zube, Helmstadt-Bargen (DE)

Correspondence Address: SAP / FINNEGAN, HENDERSON LLP, 901 NEW YORK AVENUE, NW, WASHINGTON, DC, 20001-4413, US

(21) Appl. No.: 11/486,120

(22) Filed: Jul. 14, 2006

Related U.S. Application Data
(60) Provisional application No. 60/699,367, filed on Jul. 15, 2005.

(51) Int. Cl. H04L 9/00

(52) U.S. Cl. 713/165

(57) ABSTRACT

A method and system for security management are described. According to one implementation, information concerning a plurality of export documents such as export licenses is maintained, wherein each export document is associated with a monetary amount that needs to be securitized. Further, information concerning a plurality of security positions that have been built up for securing purposes is maintained, each security position having a security amount. The implementation enables an assignment and a release of one or more export documents to a selected one of the security positions. The selected security position is then displayed together with all export documents currently assigned thereto.

### CROSS-REFERENCE TO RELATED APPLICATIONS

This application claims the benefit of priority from U.S. Provisional Application No. 60/699,367, entitled “Methods and Systems for Managing Securities Among Various Trades,” filed on Jul. 15, 2005, the disclosure of which is expressly incorporated herein by reference to its entirety.

### TECHNICAL FIELD

The invention generally relates to commercial trade management systems and, in particular, to management systems for use with securitized trades.

### BACKGROUND INFORMATION

Trades between companies in different countries often must be guaranteed with one or more securities. This is particularly common in connection with international food and agriculture trade transactions between companies outside of the European Community (i.e. non-EC countries) and companies inside the EC. For example, securities are required in connection with restitution-based trade transactions. As part of the EC's Common Agricultural Policy (CAP), when a company sells (exports) products to a customer in a lower-paying country, the seller may then apply for a subsidy—called “restitution”—from the EC. Restitution is a special concern for companies in the food and agriculture industries within Europe because it helps European Community agricultural exporters recoup subsidies for selling products to non-EC countries at lower-than-normal prices. Restitution management systems have been developed to automate the difficult filing and tracking of restitution applications.

One significant aspect of restitution management relates to the management and coordination of securities or other guarantees. Such securities are used in a variety of different foreign trade transactions. For example, securities are required to export sensitive products, such as tobacco. Securities are also required to enable use of certain simplified trade processes. To apply for an export license or for advance refund payment (ARP), specific obligations have to be fulfilled. To guarantee the observance of these obligations, a security (see Art. 15, Par. 2 & 3 EC regulation number 1291/2000) has to be provided. The security is forfeited under various circumstances. As such, there is a risk of loss of the security due to some procedural violation. The accurate management of securities, however, is often quite difficult because a given security can simultaneously be used in several different trade transactions.

Similar security management issues arise in connection with other trade transactions involving other industries or involving transactions entirely outside the EC. Accordingly, there is a need to provide a management technique for managing securities in connection with securitized trades. In particular, there is a need for a software-based tool that combines all the different processes associated with a securitized trade transactions and administers corresponding securities automatically.

### SUMMARY

In one embodiment, a computer-implemented method of managing the assignments of export documents to security positions is provided. The method comprises maintaining information concerning a plurality of export documents, each export document being associated with a monetary amount that needs to be securitized; maintaining information concerning a plurality of security positions that have been built up for securing purposes, each security position having a security amount; enabling an assignment of one or more export documents to a selected one of the security positions; calculating for the selected security position a difference between the respective security amount and the aggregated monetary amounts of all the export documents assigned to the selected security position; and displaying the calculated difference to indicate for the selected security position the remaining security amount that can still be consumed.

In a further embodiment, a computer-implemented method of managing the assignments of export documents to security positions is provided. The method comprises maintaining information concerning a plurality of export documents, each export document being associated with a monetary amount that needs to be securitized; maintaining information concerning a plurality of security positions that have been built up for securing purposes, each security position having a security amount; determining the monetary amount associated with an export document that has not yet been assigned to one of the security positions; based on the monetary amount of the export document, selecting a security position such that the aggregated amounts of all export documents, if any, currently assigned to the security position and of the export document that has not yet been assigned do not exceed the security amount of the security position; and automatically assigning the export document to the selected security position.

In another embodiment, a computer-implemented method of managing the assignments of export documents to security positions is provided. The method comprises maintaining information concerning a plurality of export documents, each export document being associated with a monetary amount that needs to be securitized; maintaining information concerning a plurality of security positions that have been built up for securing purposes, each security position having a security amount; enabling an assignment and a release of one or more export documents to a selected one of the security positions; in response to each new assignment or release for the selected security position, automatically calculating and displaying a difference between the respective security amount and the aggregated monetary amounts of all the export documents, if any, assigned to the selective security position to indicate for the selected security position the remaining security amount that can still be consumed.

In yet another embodiment, a computer-implemented method of managing the assignments of export documents to security positions is provided. The method comprises maintaining information concerning a plurality of export documents, each export document being associated with a monetary amount that needs to be securitized; maintaining information concerning a plurality of security positions that have been built up for securing purposes, each security position having a security amount; enabling an assignment and a release of one or more export documents to a selected one of the security positions; and displaying the selected security position together with all export documents currently assigned thereto.

In a further embodiment, a system for managing the assignment of export documents to security positions is provided. The system comprises a first storage for maintaining information concerning a plurality of export documents, each export document being associated with a monetary amount that needs to be securitized; a second storage for maintaining information concerning a plurality of security positions that have been built up for securing purposes, each security position having a security amount; a control element for enabling an assignment of one or more export documents to a selected one of the security positions; a processor for calculating for the selected security position a difference between the respective security amount and the aggregated monetary amounts of all the export documents assigned to the selected security position; and a display for displaying the calculated difference to indicate for the selected security position the remaining security amount that can still be consumed.

In a still further embodiment, an apparatus comprising a computer processor and a memory coupled to the processor is provided. The memory is encoded with one or more programs that may perform the steps of any of the methods described herein. In one embodiment, the memory is encoded with one or more programs that may perform the steps of maintaining information concerning a plurality of export documents, each export document being associated with a monetary amount that needs to be securitized; maintaining information concerning a plurality of security positions that have been built up for securing purposes, each security position having a security amount; enabling an assignment of one or more export documents to a selected one of the security position; calculating for the selected security position a difference between the respective security amount and the aggregated monetary amounts of all the export documents assigned to the selected security position; and displaying the calculated difference to indicate for the selected security position the remaining security amount that can still be consumed.

### BRIEF DESCRIPTION OF THE DRAWINGS

Further aspects of the invention will be apparent from the following detailed description, the attached claims, and the accompanying drawings wherein:

FIGS. 1 to 4 illustrate steps performed according to various disclosed method embodiments;

FIG. 5 provides a high-level overview of an embodiment of a computer-based system for managing the assignments of export documents to security positions;

FIG. 6 provides a more detailed overview of an embodiment of a computer based system for managing the assignments of export documents to security positions; and

FIGS. 7 to 12 illustrate graphical user interfaces for use in displaying information pertaining to the assignments of export documents to security positions.

### DETAILED DESCRIPTION

The following description, for purposes of explanation and not limitation, describes specific details, such as particular sequences of steps and various system configurations, in order to provide a further understanding of the present invention. It will be apparent to one skilled in the art, however, that the present invention may be practiced in other embodiments that depart from these specific details. In particular, while some of the following embodiments focus on the management of security positions for restitution purposes, the invention may also be practiced in non-restitution contexts that require the assignment of export documents to security positions. Furthermore, while specific examples for export documents and security positions are described, the invention is not limited to the examples presented herein. Rather, the invention is defined by the claims appearing at the end of this specification.

Those skilled in the art will also appreciate that the functions explained herein may be implemented using software functioning in conjunction with a programmed microprocessor or general purposes computer, and/or using an application specific integrated circuit (ASIC). It will also be appreciated that while the current invention is primarily described as a method, it may also be embodied in computer program product as well as an apparatus comprising a computer processor and a memory coupled to the processor, wherein the memory is encoded with one or more programs that may perform the methods disclosed herein.

The security management features of the invention can be implemented in connection with a global trade service (GTS) restitution risk management system, such as described in the SAP Online Help Tutorial “Anwendungshilfe SAP Risk Management Restitution,” Release 3.0 of 4 Oct. 2004, incorporated herein by reference.

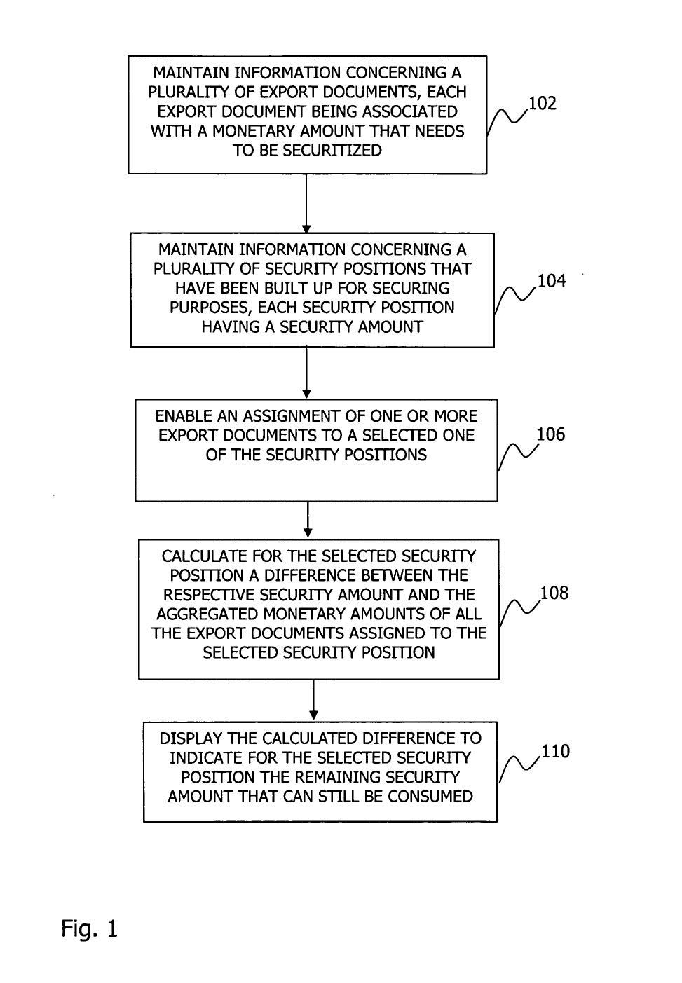

FIG. 1 shows a flowchart 100 of a first method embodiment for security management. In step 102, information concerning a plurality of export documents such as export licenses and export shipment documents is maintained. In the context of the disclosed embodiments, information maintenance may include keeping the information in a storage that serves as an information source. The storage may include a database, and the information may be maintained in the form of one or more database records. In this regard, information maintenance may include creating, modifying and/or deleting one or more database records.

Each export document is associated with a monetary amount that needs to be securitized. In the one embodiment, for example, an export document may comprise a set of information (e.g. a database record) that relates to a particular trade process stretching between different countries and/or different trade organizations (e.g., the North American Free Trade Agreement (NAFTA), the European Community (EC), etc.).

In step 104, information concerning a plurality of security positions that have been built up for securing purposes is maintained. Security positions may include, for example, one or more of the following: cash payments, guarantor's guarantees, mortgages, bailments, etc. Each of the security positions has a monetary security amount that typically ranges from a few thousand to several million U.S. dollars (or an equivalent thereof in another currency such as in Euro). For each security position, a set of information (e.g. a database record) may be kept in a storage that serves as an information source.

In step 106, an assignment of one or more export documents to a selected one of the security positions is enabled. As used herein, the term “enabling an assignment” denotes at least the technical possibility of establishing an association between the information maintained for a first entity (such as an export document) and the information maintained for a second entity (such as a security position). The association may, for example, be performed by linking one or more first database records relating to the first entity with one or more second database records relating to the second entity. In one embodiment, the assignment is enabled by a mechanism (e.g. a program code portion) that automatically performs the assignment based on a set of predefined decision rules. In another embodiment, the assignment is enabled by a graphically displayed control button or other control elements that may be activated by a user (using, e.g., a computer mouse or any other input device). Assignments may be enabled in other ways as well (e.g., manually typing in the required assignment data, etc.).

In connection with an assignment, calculations may be performed (step 108). The calculations may be part of the predefined decision rules mentioned above in connection with step 106. However, the calculations of step 108 could also be performed after an assignment has actually taken place. Alternatively, the calculations may take place after a user has requested a particular assignment in step 106, but before the requested assignment is actually effectuated and/or confirmed.

The calculations performed in step 108 aim at determining the difference between the security amount of the selected security position and the aggregated monetary amounts of all the export documents assigned to (and, in one embodiment, requested to be assigned to) the selected security position. Preferably, the difference is automatically calculated for the selected security position in response to newly assigning one of the export documents to the selected security position.

In step 110, the calculated difference is displayed as an indication of the remaining security amount that can still be consumed with respect to the selected security position. Should the calculated difference be negative, a warning could be output and displayed in addition to or instead of the calculated difference. In the case of a negative difference, additional steps such as rejecting a requested assignment of one or more export documents to the selected security position may take place.

In one embodiment, a list of security positions together with the respectively calculated difference may be displayed. At least for one or more selected ones of the listed security positions, information relating to one or more of the respectively assigned export documents may be presented. The presented information may include an export document description and/or an export document identifier. In addition to information pertaining to security positions and export documents, due dates associated with at least one of the listed security positions and export documents may be displayed. This facilitates the monitoring of due dates and thus reduces the risks of forfeiture of a particular security position or portion thereof.

Display of the information pertaining to the security positions and export documents may include permitting direct navigation to the information. The direct navigation facilitates the triggering of actions such as the creation of a new assignment, the release of an existing assignment, the creation of at least one of a new security position and a new export document (e.g. in the form of a database record) within the system, and deletion of at least one of an existing security position and an existing export document within the system.

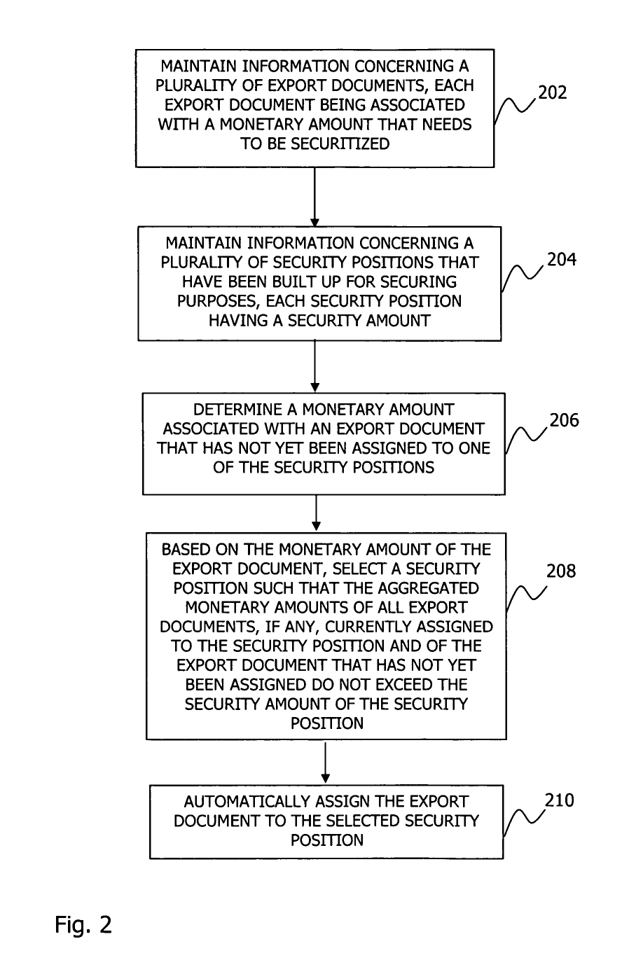

FIG. 2 shows a flowchart 200 of a further method embodiment for managing the assignments of export documents to security positions. The first two steps 202 and 204 are similar to the corresponding steps 102 and 104 explained above in relation to the flowchart 100 shown in FIG. 1. A more detailed description will thus be omitted here.

In a further step 206, a monetary amount associated with an export document that has not yet been (permanently) assigned to one of the security positions is determined. The monetary amount may be calculated, received as an input parameter, or it may be determined otherwise. The determination of the monetary amount in step 206 may include calculating the monetary amount based on (e.g. as a percentage of) a refund expected for the trade transaction underlying the export document that is to be assigned.

In step 208, and based on the monetary amount determined in step 206 for the export document that is to be assigned, a security position is selected for assignment. The selection in step 208 is performed such that the aggregated monetary amounts of all expert documents, if any, currently assigned to the security position and of the export document that has not yet been assigned do not exceed the security amount of the security position. As there exists typically more than one security position that fulfills the criterion in step 208, several security positions meeting this criterion may be identified first, followed by a selection of a particular one of the identified positions in a sub-step not shown in FIG. 2. The selection in the sub-step may be performed in a random manner, or it may be based on predefined selection rules (e.g. with the intention of minimizing or maximizing the difference between the respective security amount and the aggregated monetary amounts).

In step 210, the export document is automatically assigned to the selected security position. Thus, the assignment may be performed, if required, without human interaction.

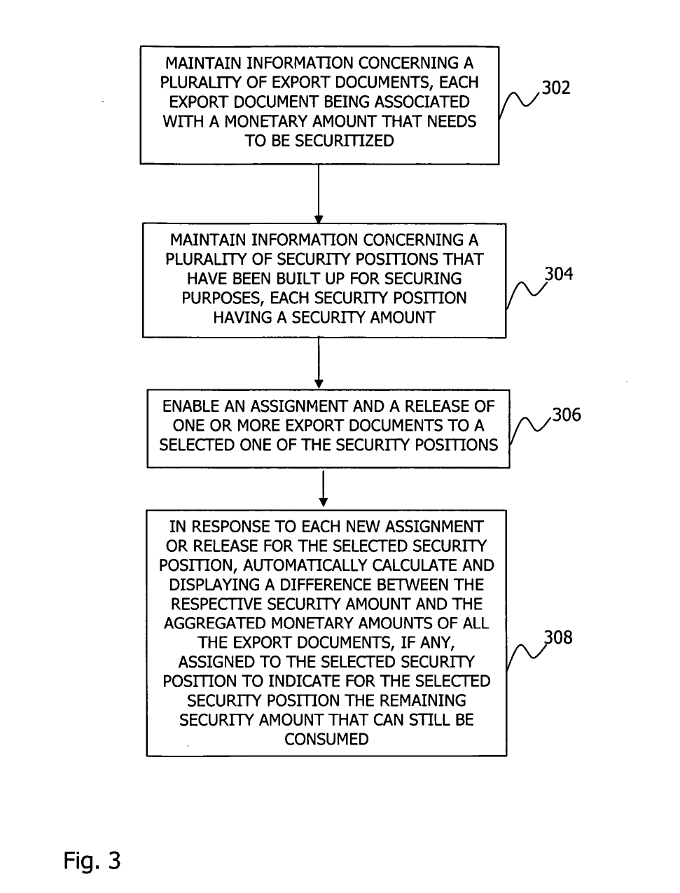

FIG. 3 shows a flowchart 300 of a further method embodiment for managing the assignments of export documents to security positions. Steps 302 to 306 of the embodiment shown in FIG. 3 correspond to steps 102 to 106, respectively, of FIG. 1. However, step 306 includes enabling an assignment of one or more export documents to a selected one of the security positions, and release of such an assignment as well.

In step 308, and in response to each new assignment or new release of an assignment for the selected security position, a difference is automatically calculated and displayed. More specifically, the calculation pertains to the difference between the respective security amount of the selected one of the security positions and the aggregated monetary amounts of all the export documents, if any, currently assigned to the selected security position to indicate for the selected security position the remaining security amount that can still be consumed. In addition to displaying the calculated difference, step 308 may further comprise displaying all the export documents, if any, currently assigned to the selected one of the security positions. Accordingly, in the case of a new assignment or a release of an existing assignment, the remaining security amount of the security position concerned is automatically recalculated. In the case of a new assignment, the remaining security amount will typically decrease, whereas for the release of an assignment, the remaining security amount will typically increase.

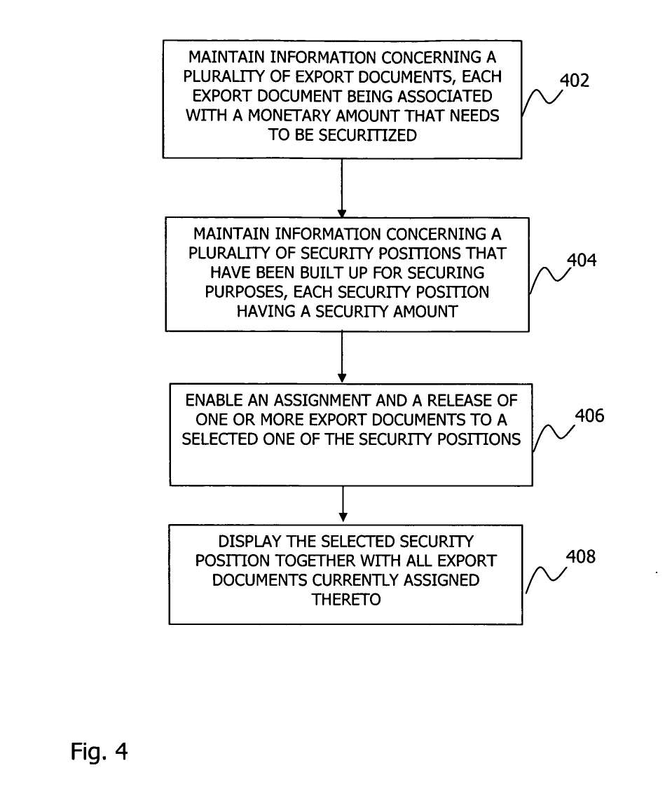

A further method embodiment for managing the assignments of export documents to security positions is illustrated in the flowchart 400 of FIG. 4. In this flowchart 400, steps 402 to 406 correspond to steps 302 to 306, respectively, of FIG. 3.

In step 408, the selected security position together with all export documents currently assigned thereto is displayed. The security position and export document information may be displayed in the same or a similar manner as described previously in connection with FIG. 1. Although not shown, step 408 may additionally comprise enabling a direct navigation to the information maintained for at least one of the displayed security positions and export documents for triggering an action.

The various method embodiments described above with reference to FIGS. 1 to 4 may be combined in various ways. For example, individual method steps may be added or exchanged.

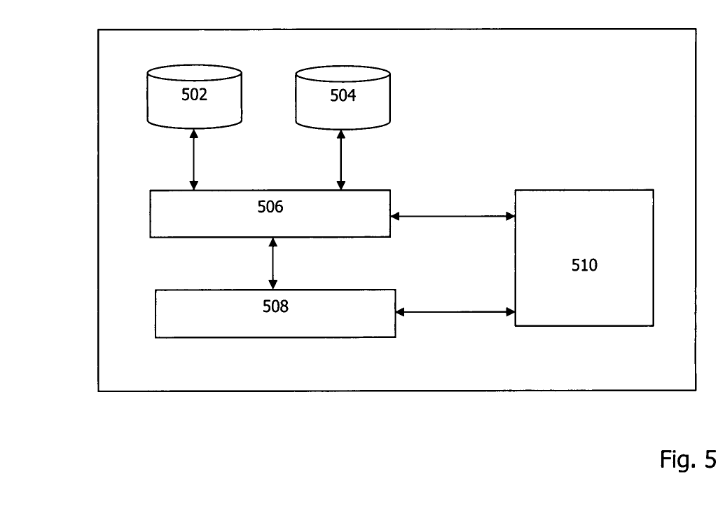

FIG. 5 shows an embodiment of a system 500 for managing the assignments of export documents to security positions. As shown in FIG. 5, the system 500 comprises a first storage 502 for maintaining information concerning a plurality of export documents, wherein each export document is associated with a monetary amount that needs to be securitized. Additionally, the system 500 comprises a second storage 504 for maintaining information concerning a plurality of security positions that have been built up for security purposes, wherein each security position has a security amount. In one embodiment, the first and second storages 502, 504 may be implemented in the form of databases or database portions.

As shown in FIG. 5, system 500 further comprises a control element 506 for enabling an assignment of one or more export documents to a selected one of the security positions. Control element 506 may be implemented in the form of a program code portion for automatically performing one or more assignments. In addition, or alternatively, control element 506 may take the form of a control button or other control element that can be activated by a user for manually performing an assignment.

A processor 508 calculates for the selected security position a difference between the respective security amount and the aggregated monetary amounts of all the exports documents assigned to the selected security position. The calculated difference is then displayed on a display 510 (e.g. a computer monitor) to indicate for the selected security position the remaining security amount that can still be consumed.

The system 500 shown in FIG. 5 can be adapted to perform each of the method embodiments described above with reference to FIGS. 1 to 4, or modifications thereof. The system 500 may be implemented as a stand-alone computer system or, alternatively, it may be integrated into a computer network.

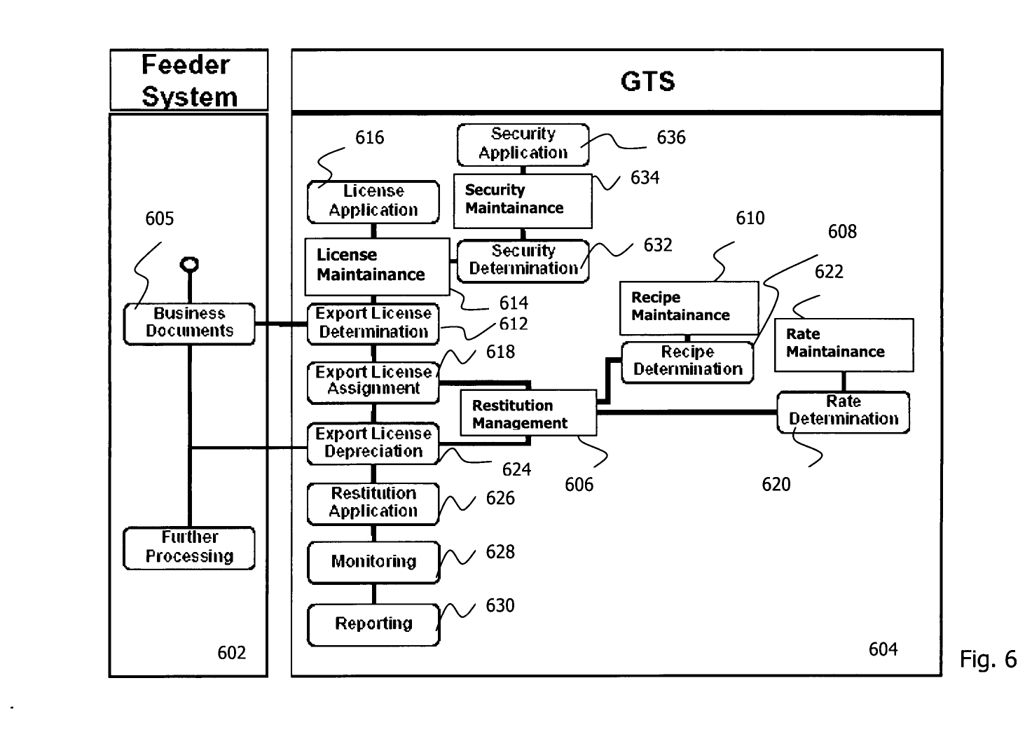

FIG. 6 shows a detailed overview of an embodiment of a risk management system 600 that is based on system 500 of FIG. 5. The risk management system 600 of FIG. 6 assists exporters in the restitution process and implements a functionality for assigning export documents to security positions in a restitution context. The system 600 thus helps to ensure that all the prerequisites for applying for and receiving export restitutions are fulfilled. It also minimizes the risk of penalization through loss of security positions (or portions thereof. In particular, the following requirements for restitution are supported by the system 600: export document maintenance and assignment, security maintenance and assignment, manufacturer's recipe maintenance, and restitution rate maintenance.

The components and the operation of the risk management system 600 will now be described in connection with an exemplary restitution process for a typical trade transaction in which products are to be delivered (exported) from a manufacturer within the EC to a customer outside the EC. In general, the procedural prerequisites required to apply for restitution are as follows. First, the products must be exported and the customs authorities must confirm the export of the products. Second, the products must have a commercial quality. Third, an export document in the form of a export license is required. In order to obtain an export license, a security position (typically a bank security) must be established and assigned to the export license. An application for restitution includes the timely submission of papers which include, for example, an export declaration, a so-called control copy “T5”, a manufacturer's recipe for each product, and an export license.

The main components of system 600 are a feeder sub-system 602 and a risk management GTS sub-system 604. With reference to FIG. 6, the restitution process starts with a sales order and a delivery document for the trade transaction being created in the feeder sub-system 602. A customer invoice or a pro form a invoice is then created in the feeder sub-system 602 based on the products that are actually delivered to the customer. The sales order, the delivery document and the customer invoice/pro form a invoice are collectively referred to as business documents 605 in FIG. 6.

The data from the business documents 605 is transferred from the feeder subsystem 602 to the risk management GTS sub-system 604, where an export document in the form of a customs export shipment document is created and mapped to the business documents 605. If an advance refund payment (ARP) is required, one or a more of existing security positions must be assigned immediately to the export shipment document, as will be described in more detail below.

The individual products listed in the export shipment document are individually checked by a restitution management component 606 in the risk management GTS sub-system 604 against product master data (including product recipe data) to determine whether they are restitution-relevant products or not. Restitution-relevant products may include basic products (e.g., sugar, cereals, eggs, rice, processed products of fruit and vegetables, milk and milk products, etc.), and/or final products, or “non-annex-1 products” (e.g., products whose ingredients include one or more of the above basic products).

In order to determine the ingredients of a particular final product by a recipe determination component 608, the manufacturer's recipes (i.e. bills of products) for all final products are maintained as master data in a recipe maintenance component 610. Based on the recipe determined by the recipe determination component 608, the restitution determination component 606 determines whether the final product is eligible for restitution.

If a particular product is eligible for restitution, an export license determination component 612 checks to determine whether the product requires an export license. To this end, the export license determination component 612 communicates with a license maintenance component 614. In the license maintenance component 614, information about each previously granted export license is maintained. The information maintained by the component 614 may include the underlying legal regulation, the license type, the license number, the period of validity, the licensed monetary amount or quantity, and the amount/quantity still available as well as the amount/quantity already consumed (or “written off”) for earlier trade transactions. The license maintenance component 614 keeps information both for existing (granted) licenses and for licenses that have only been requested (applied for) but not yet been granted. License maintenance includes creation, modification, display and/or deletion of export licenses and related information.

If the export license determination component 612 determines for a particular product that an export license is required, but the information kept by the license maintenance component 614 indicates that there is no export license available, then an application for a new export license must be made to the appropriate customs authorities. To this end, a license application component 616 is provided.

Once granted by the authorities, information about the newly granted export license (“the export document”) will be maintained by the license maintenance component 614, and a security position will be assigned to this export license. The assignment of the security position to the new export license is performed by an export license assignment component 618. The new information concerning the export license and the security position is then additionally assigned to the individual products in the export shipment document.

If the license search performed by the export license determination component 612 and the license maintenance component 614 shows that an export license is available for the product in question, then the existing license is assigned to the export shipment document. In one embodiment, for a particular product, the risk management GTS sub-system 604 determines the appropriate export license (and the security position assigned to the export license) automatically based on predefined determination rules.

In one embodiment, a rate determination component 620 determines the restitution rate for each of the products. Information about each restitution rate (e.g. the rate itself, the underlying legal regulation, the type of restitution, the associated country/country group of product destination, and the validity period) is maintained by a rate maintenance component 622. Based on information relating to the applicable restitution rate for a specific product received from the rate determination component 620, the restitution management component 606 multiplies the applicable restitution rate by the quantity of the respective products to obtain a total expected restitution amount.

An export license depreciation component 624 communicating with the restitution management component 606 may automatically depreciate the export license for the respective product by the determined monetary value/quantity. The information kept for the specific license by the license maintenance component 614 is updated accordingly. Additionally, the monetary value may be automatically depreciated from the security amount of the security position assigned to the export license.

In one embodiment, based on the above process, necessary papers are printed out and sent to the customs authorities, and the export products can be unloaded. The papers may include applications for restitutions handled by a restitution application component 626. In one embodiment, a monitoring component 628 constantly keeps track of all the papers that are necessary for the restitution process to help ensure that they arrive at the appropriate customs authorities on time. The restitution process is then closed once all the papers have arrived at the customs authorities and the authorities have confirmed the restitution amount. Once the restitution amount has been confirmed, the security position (typically a monetary portion thereof) assigned to the respective trade transaction and the associated export documents can be released.

Information relating to security positions can be entered and maintained in the risk management GTS sub-system 604 before assigning them to export licenses and/or other export documents, such as export shipment documents. In one embodiment, the security positions are also assigned to the individual products in each of the export shipment documents, as not every product listed in the export shipment document may be eligible for restitution or require an export license. The assignment is a legal requirement of the customs authorities for export and restitution purposes. The security position can be released once the prescribed prerequisites have been fulfilled. If, however, the prerequisites are not fulfilled, the security is retained. In the case of ARP, when the customs authorities pay the restitution immediately after one has applied for it, the security must cover 110% of the total expected restitution amount as calculated by the restitution management component 606.

With respect to security management, the main components of the risk management GTS sub-system 604 are a security determination component 632, a security maintenance component 634, and a security application component 636. Using the security-related components 632, 634 and 636, the risk management GTS sub-system 604 can implement not only each of the method embodiments illustrated in FIGS. 1 to 4, but also other assignment processes.

The security determination component 632 allows for an automatic determination of an appropriate security position for the assignment to an export document (e.g., to an export license and/or an export shipment document). To this end, the security determination component 632 applies one or more determination rules that have previously been defined, for example, by a user. The security determination component 632 obtains information about all available security positions from the security maintenance component 634. If it turns out that no appropriate security position is available, the security application component 636 assists in the application for a new security position. Once the new security position becomes available, the security maintenance component 634 will be updated accordingly.

The configuration and operation of the security maintenance component 634 will now be described in more detail. The security maintenance component 634 allows for a maintenance of information relating to individual security positions, including creation, modification, display and deletion of a security position. The information kept by the security maintenance component 634 for an individual security position typically includes general security data, assignment data and holding data. As for the general security data, information about a security type, an official security number, a monetary security amount and a security description (e.g. bank references) are kept. With respect to the holding data, information about a holding date, an amount held, a reference number for holding and a description of the reason for holding are maintained.

As for the assignment data, the security maintenance component 634 keeps information about the usage of the security position. It may, for example, be specified that the security position is usable for one or both of an export license and an ARP. The usage information can then be enforced in connection with a manual or automatic assignment of the security position. Further assignment data include an identification of one or more assigned export documents (trade transactions) binding the security position or a monetary portion thereof. Based on the identification information, the identified export documents may automatically be determined and updated as required during the assignment and release processes. Other assignment data maintained by the security assignment component 634 include, for each assigned export document, the date of assignment, the portion of the total monetary security amount consumed by the export document, any amounts already released, and the date of release. In certain cases, the date of release is provided by the customs authorities, and the corresponding data might have to be entered and maintained manually, including the date of provision of papers, the due date (e.g., date of assignment/binding plus 12 months) and any extensions to the due date.

In a standard export process, in which a security position is directly assigned to an export license, the assignment can be released as soon as a confirmation of restitution is received from the customs authorities. For export processes involving APP, in which a security position must also be assigned to an export shipment document, the assignment can only be released once all required papers have been submitted. In each case, and following the release, the monetary amount of the security position bound by the assignment can be used for new trade transactions. The release of an assignment between a security position and an export document involves a manual or automatic update of the security information kept by the security maintenance component 634.

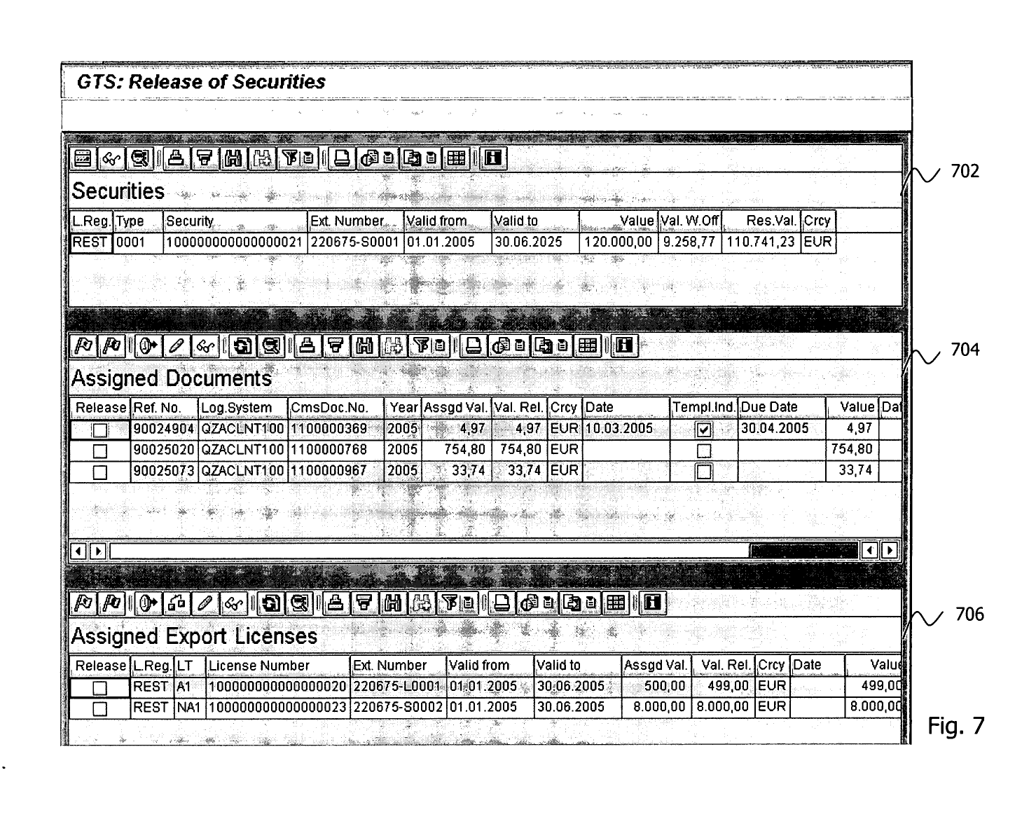

In one embodiment, release of an assignment for a particular security position is performed using a graphical user interface (GUI) 700 as shown in FIG. 7. The GUI 700 is part of an “integrated security monitoring cockpit” that efficiently assists a user in maintaining and managing securities independent of the actual trade transactions being performed. In particular, the GUI 700 and related GUIs of the “monitoring cockpit” assist in monitoring all existing security positions and export documents to detect any discrepancies so that prompt action may be taken before possibly losing securities.

The GUI 700 lists in an upper GUI portion 702 all available security positions together with the export documents assigned to a selected one of the listed security positions. It should be noted that for the sake of simplicity, only a single security position is listed in the GUI portion 702. The list will, however, in most circumstances include multiple such items. The individual export documents assigned to the particular security position that is shown in the upper GUI portion 702 are listed in two lower GUI portions 704, 706. If several security positions were listed in the upper GUI portion 702, the lower GUI portions 704, 706 would show only the export documents assigned to a single selected one of the listed security positions.

The lower GUI portion 704 lists all the individual export shipment documents (simply denoted as “documents”) assigned to the selected security position. In the present case, the list of export shipment documents includes three items. The other lower GUI portion 706 lists all the individual export licenses assigned to the selected security position. In the present case, the list of export licenses includes two items.

Each of the GUI portions 702, 704, and 706 displays part of the information maintained within the risk management GTS sub-system 604 for each of the listed items. As for the security positions, the information displayed in GUI portion 702 includes the legal regulation underlying the particular security position (here: restitution), the security type (here: 0001), the system security number (here: 100000000000000023), the external security number (here: 220675-S0001), the validity period (here: from 01.01.2005 to 30.06.2025), the security amount (here: 120.000,00), the security amount that has already been written off (here: 9.258,77), the remaining security amount that can still be consumed (here: 110.741.23), and the currency in which the security position is provided (here: Euro). As can be gathered from FIG. 7, the security amount that has already been written off (or consumed) amounts to the aggregated monitory amounts associated with the five export documents (export shipment documents/export licenses) assigned to the particular security position listed in the upper GUI portion 702.

The information displayed for each export shipment document in the lower GUI portion 704 includes a release indicator that can be set manually, a reference number of an associated billing document (here: 90024904 for the first item), a system number (here: QZACLNT100 for the first item), a customs document number (here: 1100000369 for the first item), a document year (here: 2005 for the first item), a portion of the security amount assigned to the Listed export shipment document (here: 4,97 for the first item), a monetary amount that will be released for the specific export shipment document (here: 4,97 for the first item), a currency for the listed amounts (here: Euro), the date on which 95% of the export license underlying the export shipment document has been written off, in which case the assignment (and thus the corresponding portion of the security amount) can be released (here: 10.03.2005 for the first item), a template indicator indicating that a definitive export confirmation has been received from the customs authorities (here: indicator is set for the first item), a due date by which the necessary paper have to be provided to the customs authorities (here: 30.04.2005 for the first item), and a monetary amount that needs to be securitized for the particular export shipment document (here: 4,97 for the first item). The release indicator mentioned first shall only be set once the definitive export confirmation has been received from the customs authorities. From the setting of the template indicator one may infer whether or not the export confirmation has already been obtained. In other words, once the template indicator is set one may also set the release indicator to release an assignment. The actual release is only effectuated once a refresh button in the upper icon bar of the GUI portion 704 is activated.

A for the export licenses assigned to the particular security position listed in the upper GUI portion 702, the information displayed for each export license in the lower GUI portion 706 includes a release indicator that can be set manually, the legal regulation underlying the particular export license (here: restitution for the first item), the license type (here: AI for the first item), the system license number (here: 100000000000000020 for the first item), the external license number (here: 220675-L000I for the first item), the validity period (here: 01.01.2005 to 30.06.2005 for the first item), a portion of the security amount assigned to the listed export license (here: 500,00 for the first item), a monetary amount will be released for the specific export license (here: 499,00 for the first item), a currency for the listed amounts (here: Euro), the date on which 95% of the export license underlying the export shipment document has been written off, and a monetary amount that needs to be securitized for the particular export license (here: 499,00 for the first item).

Each of the GUI portions 702, 704, and 706 has an icon bar that permits various actions in relation to a selected one of the respectively listed items. One of the actions that can be performed in this regard is a direct navigation to the information centrally kept for each of the listed items.

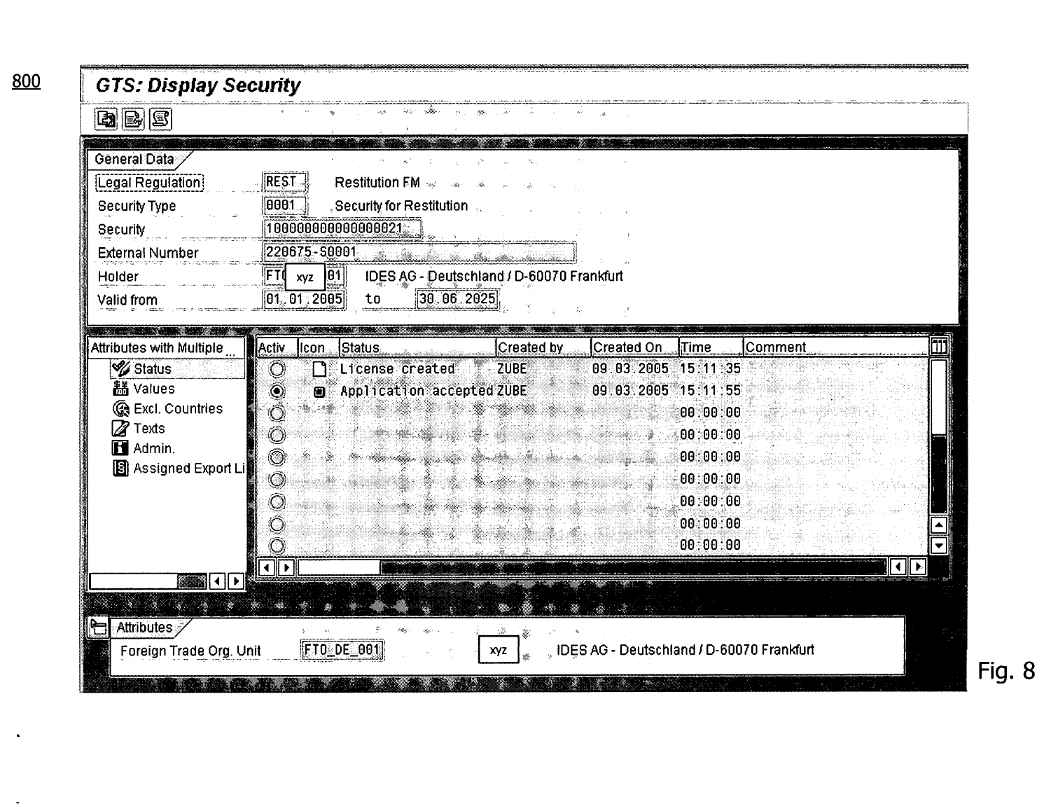

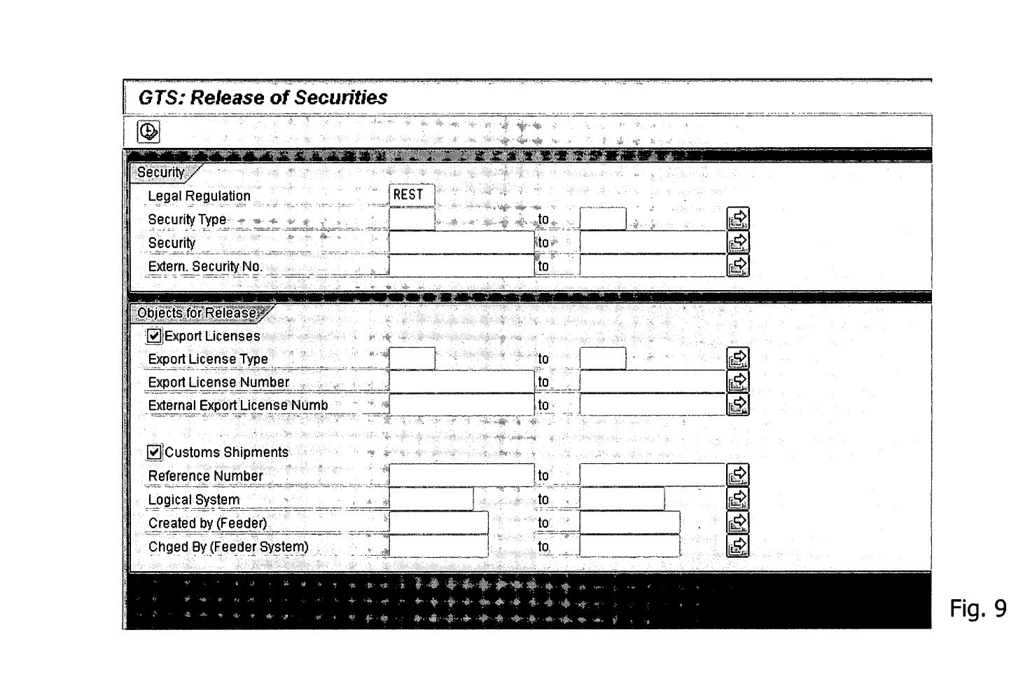

For the security position listed in the GUI portion 702, the direct navigation leads to one of the GUIs 800 and 900 shown in FIGS. 8 and 9, respectively. The GUI 800 of FIG. 8 shows information for the selected security position, including the holder of the security position and an assignment history, and allows for a maintenance of this information. The GUI 900 of FIG. 9 allows for a manual release of existing assignments between the selected security position and the various export documents.

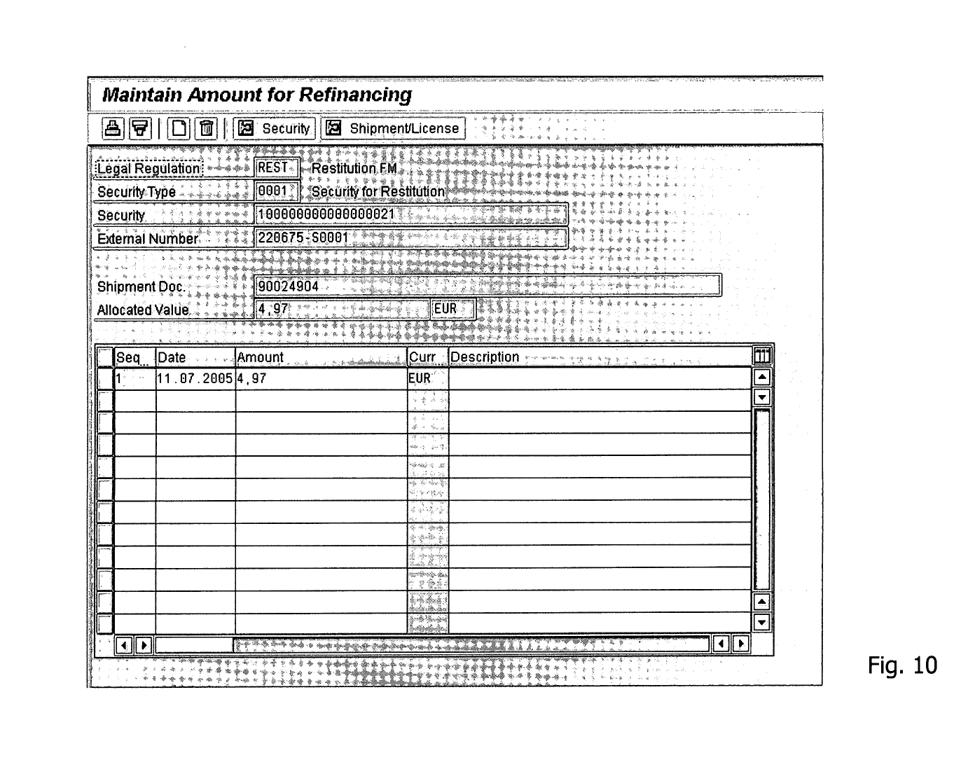

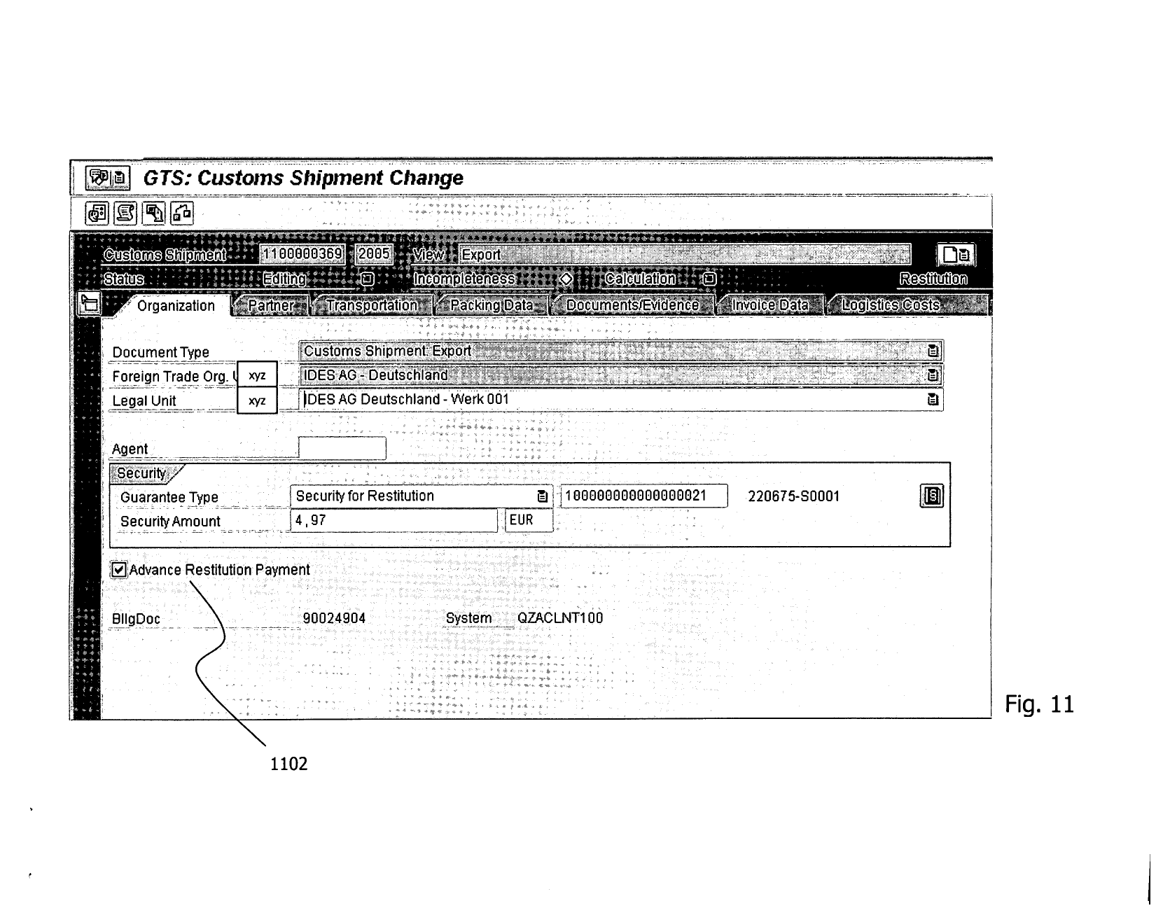

The GUI 1000 of FIG. 10 allows for a maintenance of the amount for refinancing in relation to a selected one of the export shipment documents (here: for the first item in the GUI portion 704). The GUI 1100 of FIG. 11 displays information for the selected export shipment document and allows for a maintenance of this information. In particular, the GUI 1100 shows information about the security position assigned to the selected export shipment document including the portion of the overall security amount of this position allocated to the selected export shipment document. In some cases, more than one security position may be assigned to a particular export shipment document. Further, by setting the ARP indicator 1102, the template indicator for the respective export shipment document in the GUI 700 is set also.

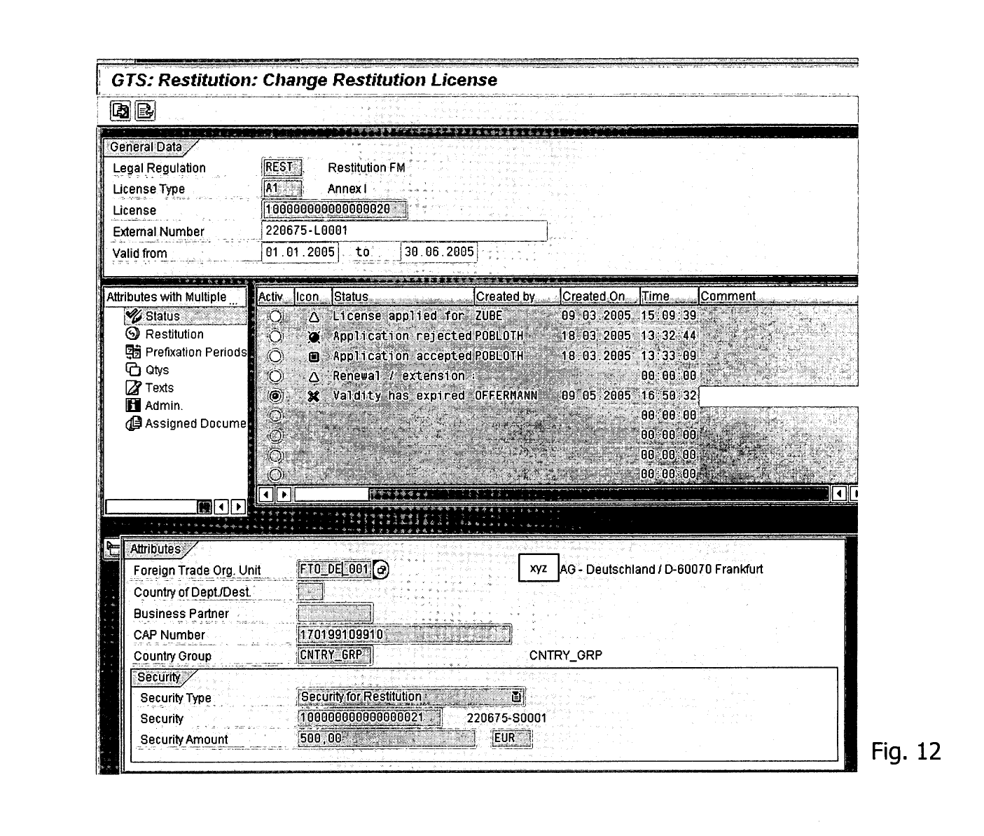

The GUI 1200 of FIG. 12 shows information for a selected export license and allows for a maintenance of this information. GUI 1200 shows information about the security position assigned to the selected export license, including the portion of the overall security amount of this position allocated to the selected export license. Additionally, the GUI 1200 shows the application history of the export license in question, including any extensions and expiration. Thus, export licenses can efficiently be monitored.

While illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. A computer-implemented method of managing the assignments of export documents to security positions, comprising:
maintaining information concerning a plurality of export documents, each export document being associated with a monetary amount that needs to be securitized;
maintaining information concerning a plurality of security positions that have been built up for securing purposes, each security position having a security amount;
enabling an assignment of one or more export documents to a selected one of the security positions;
calculating for the selected security position a difference between the respective security amount and the aggregated monetary amounts of all the export documents assigned to the selected security position; and
displaying the calculated difference to indicate for the selected security position the remaining security amount that can still be consumed.

2. The method of claim 1, wherein the difference is automatically calculated for the selected security position in response to newly assigning one of the export documents to the at least one security position.

3. The method of claim 1, further comprising outputting a warning if the calculated difference is negative.

4. The method of claim 1, further comprising rejecting an assignment of one of the export documents to the selected security position if the calculated difference is negative.

5. The method of claim 1, further comprising enabling a release of the assignment of one of the export documents to a particular security position.

6. The method of claim 5, further comprising automatically re-calculating the difference for the particular security position in response to the release of one of the assignments.

7. The method of claim 6, further comprising displaying the recalculated difference for the selected security position.

8. The method of claim 1, wherein displaying the calculated difference comprises displaying a list of security positions together with the respective differences.

9. The method of claim 8, further comprising displaying a list of one or more of the export documents assigned to at least one of the listed security positions.

10. The method of claim 8 or 9, further comprising displaying due dates associated with at least one of the listed security positions and export documents.

11. The method of claim 8 or 9, further comprising enabling a direct navigation to the information maintained for at least one of the listed security positions and export documents for triggering an action.

12. The method of claim 11, wherein the action includes at least one of a creation of a new assignment and release of an existing assignment.

13. The method of claim 11, wherein the action includes a creation of at least one of a new security position and a new export document.

14. The method of claim 11, wherein the action includes a deletion of a least one of an existing security position and an existing export document.

15. The method of claim 1, wherein the security positions include at least one of cash payments, guarantor's guarantees, mortgages, and bailments.

16. The method of claim 1, wherein the export documents include at least one of export licenses and customs shipment documents.

17. The method of claim 1, further comprising enabling an assignment of the security positions to one or more restitution-relevant products.

18. The method of claim 1, wherein the information concerning the plurality of security positions and the information concerning the plurality of export documents are maintained independently from each other.

19. A computer-implemented method of managing the assignments of export documents to security positions, comprising:
maintaining information concerning a plurality of export documents, each export document being associated with a monetary amount that needs to be securitized;
maintaining information concerning a plurality of security positions that have been built up for securing purposes, each security position having a security amount;
determining the monetary amount associated with an export document that has not yet been assigned to one of the security positions;
based on the monetary amount of the selected export document, selecting a security position such that the aggregated monetary amounts of all export documents, if any, currently assigned to the security position and of the export document that has not yet been assigned do not exceed the security amount of the security position; and
automatically assigning the export document to the selected security position.

20. The method of claim 19, wherein determining the monetary amount includes calculating the monetary amount based on a refund expected for the trade transaction underlying the export document that has not yet been assigned.

21. A computer-implemented method of managing the assignments of export documents to security positions, comprising:
maintaining information concerning a plurality of export documents, each export document being associated with a monetary amount that needs to be securitized;
maintaining information concerning a plurality of security positions that have been built up for securing purposes, each security position having a security amount;
enabling an assignment and a release of one or more export documents to a selected one of the security positions;
in response to each new assignment or release for the selected security position, automatically calculating and displaying a difference between the respective security amount and the aggregated monetary amounts of all the export documents, if any, assigned to the selected security position to indicate for the selected security position the remaining security amount that can still be consumed.

22. The method of claim 21, further comprising displaying a list of all the export documents, if any, currently assigned to the selected security position.

23. A computer-implemented method of managing the assignments of export documents to security positions, comprising:
maintaining information concerning a plurality of export documents, each export document being associated with a monetary amount that needs to be securitized;
maintaining information concerning a plurality of security positions that have been built up for securing purposes, each security position having a security amount;
enabling an assignment and a release of one or more export documents to a selected one of the security positions;
displaying the selected security position together with all export documents currently assigned thereto.

24. The method of claim 22, further comprising enabling a direct navigation to the information maintained for at least one of the displayed security positions and export documents for triggering an action.

25. A system for managing the assignments of export documents to security positions, comprising:
a first storage for maintaining information concerning a plurality of export documents, each export document being associated with a monetary amount that needs to be securitized;
a second storage for maintaining information concerning a plurality of security positions that have been built up for securing purposes, each security position having a security amount;
a control element for enabling an assignment of one or more export documents to a selected one of the security positions;
a processor for calculating for the selected security position a difference between the respective security amount and the aggregated monetary amounts of all the export documents assigned to the selected security position; and
a display for displaying the calculated difference to indicate for the selected security position the remaining security amount that can still be consumed.

26. An apparatus comprising a computer processor and a memory coupled to the processor, wherein the memory is encoded with one or more programs that, when executed, perform the steps of:
maintaining information concerning a plurality of export documents, each export document being associated with a monetary amount that needs to be securitized;
maintaining information concerning a plurality of security positions that have been built up for securing purposes, each security position having a security amount;
enabling an assignment of one or more export documents to a selected one of the security positions;
calculating for the selected security position a difference between the respective security amount and the aggregated monetary amounts of all the export documents assigned to the selected security position; and
displaying the calculated difference to indicate for the selected security position the remaining security amount that can still be consumed.
